(19) United States
(12) Patent Application Publication
(10) Pub. No.: US 2007/0115297 A1
(43) Pub. Date: May 24, 2007

(54) Display apparatus, display method, display system, server, and recording medium having program recorded thereon

(75) Inventor: Koji Hirose, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; INCREMENT P CORPORATION

(21) Appl. No.: 11/584,487

(22) Filed: Oct. 23, 2006

(30) Foreign Application Priority Data
Oct. 21, 2005 (JP) P2005-307359

(51) Int. Cl. G09G 5/02

(52) U.S. Cl. 345/597

(57) ABSTRACT

A display apparatus employs a display of a non-emitting type such as a liquid crystal display for the display unit, the system control unit of a mobile terminal converts the color of the object having the largest display area among the objects constituting the image of map image data displayed on the screen of the display unit, to white, and causes the display unit to display the converted map image data.

### BACKGROUND OF THE INVENTION

1. Field of the Invention

The present invention relates to a display apparatus that displays information such as content data, a display method, a display system, a server, and a recording medium having a program recorded thereon.

2. Description of the Related Art

At present, active developments are being made in portable information terminals having screens, such as a liquid crystal display, for displaying information, such as portable telephone devices, PDAs (Personal Digital Assistants), digital cameras, and car navigation apparatuses.

For a portable information terminal driven by a battery or a dry cell to endure long-time mobile usage, it is most essential to restrict power consumption to a small amount. As one means, power consumption can be effectively reduced by adjusting the screen display.

Also, to save energy, it is preferable to reduce the amount of power consumed in each screen display operation in devices other than the above portable information terminals, such as display apparatuses and television sets.

Conventionally, a power-saving effect is achieved by activating a screen saver after a predetermined period of time, switching off the screen display, or darkening the screen.

In the image display method disclosed in Japanese Patent Application Laid-Open No. 2004-246099, for example, a convrsion to color-difference signal component and luminance signal component is performed for each input image signal, so as to emphasize the luminance signal components. Also, the light quantity of the backlight of the liquid crystal display is reduced. Thus, a power-saving effect is achieved.

However, the above-described conventional operations are performed, regardless of the intention of each user. For example, inconvenience is caused to the user, if screen displays are changed while the user is watching the screen. Also, when the screen is darkened, the problem of poor visibility is caused.

Also, the power consumption of a liquid crystal display can be reduced by the image display method disclosed in Japanese Patent Application Laid-Open No. 2004-246099, but this method cannot be implemented in displays which does not have backlights, such as CRT (Cathode Ray Tube) displays, plasma displays, and organic EL (Electro Luminescence) displays.

### SUMMARY OF THE INVENTION

The present invention aims to solve the above problems, and it is an object of the present invention to provide a display apparatus that can reduce the power consumption in a display operation in accordance with various display techniques. The present invention also provides a display method, a display system, a server, and a recording medium having a program recorded thereon.

In order to solve the above problems, the invention of claim 1 relates to a display apparatus that has a display device which displays information on a screen, comprising:

a color converting device which converts a color of a display element having the largest display area among display elements constituting an image of the information displayed on the screen, to such a color as to minimize power consumption in the display operation, in accordance with a display technique utilized by the display device; and

a display control device which causes the display device to display the information after the conversion.

The invention of claim 9 relates to a display method which is utilized in a display apparatus including a display device that displays information on a screen,

the display method comprising:

a process of converting a color of a display element having the largest display area among display elements constituting an image of the information displayed on the screen, to such a color as to minimize power consumption in the display operation, in accordance with a display technique utilized by the display device; and

a process of causing the display device to display the information after the conversion.

The invention of claim 10 relates to a display system comprising:

a display apparatus which includes a display device which displays information on a screen; and

a server which can be connected to the display apparatus via a network,

the server including:

a receiving device which receives technique information indicating a display technique utilized by the display device, the technique information being transmitted from the display apparatus;

a color converting device which converts a color of a display element having the largest display area among display elements constituting an image of the information displayed on the screen, to such a color as to minimize power consumption in the display operation, in accordance with the display technique utilized by the display device; and

a transmitting device which transmits the information after the conversion to the display apparatus,

the display apparatus including:

a transmitting device which transmits the technique information to the server;

a receiving device which receives information transmitted from the server; and

a display control device which causes the display device to display the received information.

The invention of claim 11 relates to the display apparatus of the display system according to claim 10, comprising the display device, the transmitting device, the receiving device, and the display control device.

The invention of claim 12 relates to a recording medium which has a program recorded therein in such a manner that a computer contained in the display apparatus according to claim 11 can read the program,

the program causing the computer to function as the transmitting device, the receiving device, and the display control device.

The invention of claim 13 relates to the server of the display system according to claim 10, comprising the receiving device, the color converting device, and the transmitting device.

The invention of claim 14 relates to a recording medium which has a program recorded therein in such a manner that a computer contained in the server according to claim 13 can read the program,

the program causing the computer to function as the receiving device, the color converting device, and the transmitting device.

The invention of claim 15 relates to a display method which is utilized in a display system which includes a display apparatus and a server, the display apparatus having a display device which displays information on a screen, and the server being connectable to the display apparatus via a network,

the display method comprising:

a process of the display apparatus transmitting technique information indicating a display technique utilized by the display device to the server;

a process of the server receiving the technique information transmitted from the display apparatus;

a process of the server converting a color of a display element having the largest display area among display elements constituting an image of the information displayed on the screen, to such a color as to minimize power consumption in the display operation, in accordance with the display technique utilized by the display device;

a process of the server transmitting the information after the conversion to the display apparatus;

a process of the display apparatus receiving information transmitted from the server; and

a process of the display apparatus causing the display device to display the received information.

The invention of claim 16 relates to a display system comprising:

a display apparatus which includes a display device which displays information on a screen; and

a server which can be connected to the display apparatus via a network,

the server including:

a receiving device which receives technique information indicating a display technique utilized by the display device, the technique information being transmitted from the display apparatus; and

a transmitting device which transmits a program in accordance with the received technique information to the display apparatus, the program being used for controlling an operation of the display apparatus,

the display apparatus including:

a transmitting device which transmits the technique information to the server;

a receiving device which receives the program transmitted from the server;

a color converting device which converts a color of a display element having the largest display area among display elements constituting an image of the information displayed on the screen under control of the received program, to such a color as to minimize power consumption in the display operation, in accordance with the display technique utilized by the display device under control of the received program; and

a display control device which causes the display device to display the converted information under control of the received program.

The invention of claim 17 relates to the display apparatus of the display system according to claim 16, comprising the display device, the transmitting device, the receiving device, the color converting device, and the display control device.

The invention of claim 18 relates to a recording medium which has a program recorded therein in such a manner that a computer contained in the display apparatus according to claim 17 can read the program,

the program causing the computer to function as the color converting device and the display control device.

The invention of claim 19 relates to the server of the display system according to claim 16, comprising the receiving device and the transmitting device.

The invention of claim 20 relates to a recording medium which has a program recorded therein in such a manner that a computer contained in the server according to claim 19 can read the program,

the program causing the computer to function as the receiving device and the transmitting device.

The invention of claim 21 relates to a display method which is utilized in a display system which includes a display apparatus and a server, the display apparatus having a display device which displays information on a screen, and the server being connectable to the display apparatus via a network,

the display method comprising:

a process of the display apparatus transmitting technique information indicating a display technique utilized by the display device to the server;

a process of the server receiving the technique information transmitted from the display apparatus;

a process of the server transmitting a program in accordance with the received technique information to the display apparatus, the program being used for controlling an operation of the display apparatus;

a process of the display apparatus receiving the program transmitted from the server;

a process of the display apparatus converting a color of a display element having the largest display area among display elements constituting an image of the information displayed on the screen under control of the received program, to such a color as to minimize power consumption in the display operation, in accordance with the display technique utilized by the display device under control of the received program; and

a process of the display apparatus causing the display device to display the converted information under control of the received program.

### BRIEF DESCRIPTION OF THE DRAWINGS

FIG. 1 shows an example of a power-saving process in accordance with a variety of display operations of the display;

FIG. 2 schematically shows an example structure of a map information display system S in accordance with a first embodiment of the present invention;

FIG. 3 is a block diagram schematically showing an example structure of the server SV in accordance with the first embodiment;

FIG. 4 is a block diagram schematically showing an example structure of the mobile terminal T in accordance with the first embodiment;

FIGS. 5A and 5B show an example of a CLUT;

FIGS. 6A through 6D illustrate a situation in which the color of each object in map image data is converted in a display of a non-emitting type; FIG. 6A shows the map image data prior to conversion; FIG. 6B shows the luminance values of the RGB of each object prior to conversion; FIG. 6C shows the map image data after conversion; and FIG. 6D shows the luminance values of the RGB of each object after conversion;

FIGS. 7A through 7D illustrate a situation in which the color of each object in map image data is converted in a display of a light-emitting type; FIG. 7A shows the map image data prior to conversion; FIG. 7B shows the luminance values of the RGB of each object prior to conversion; FIG. 7C shows the map image data after conversion; and FIG. 7D shows the luminance values of the RGB of each object after conversion;

FIG. 8 schematically shows an example structure of a map information display system S1 in accordance with a modification of the first embodiment;

FIG. 9 schematically shows an example structure of a map information display system S2 in accordance with a second embodiment;

FIG. 10 shows an example of a reference table;

FIG. 11 schematically shows an example structure of a map information display system S3 in accordance with a modification of the second embodiment;

FIGS. 12A and 12B illustrate an example of a display simplifying process; FIG. 12A shows a specific display; and FIG. 12B shows a simpler display;

FIGS. 13A and 13B illustrate another example of a display simplifying process; FIG. 13A shows a guiding display formed with a map and a guiding arrow; and FIG. 13B shows a preliminary guiding display formed only with a guiding arrow;

FIGS. 14A and 14B illustrate yet another example of a display simplifying process; FIG. 14A shows a guiding display formed with a map and a guiding arrow; and FIG. 14B shows a preliminary guiding display formed only with a guiding arrow; and

FIG. 15 is a flowchart showing an example of the operation of the system control unit 27 of the mobile terminal T in accordance with a third embodiment.

### DESCRIPTION OF THE PREFERRED EMBODIMENTS

[1. Mechanism for Achieving Power-Saving Effect]

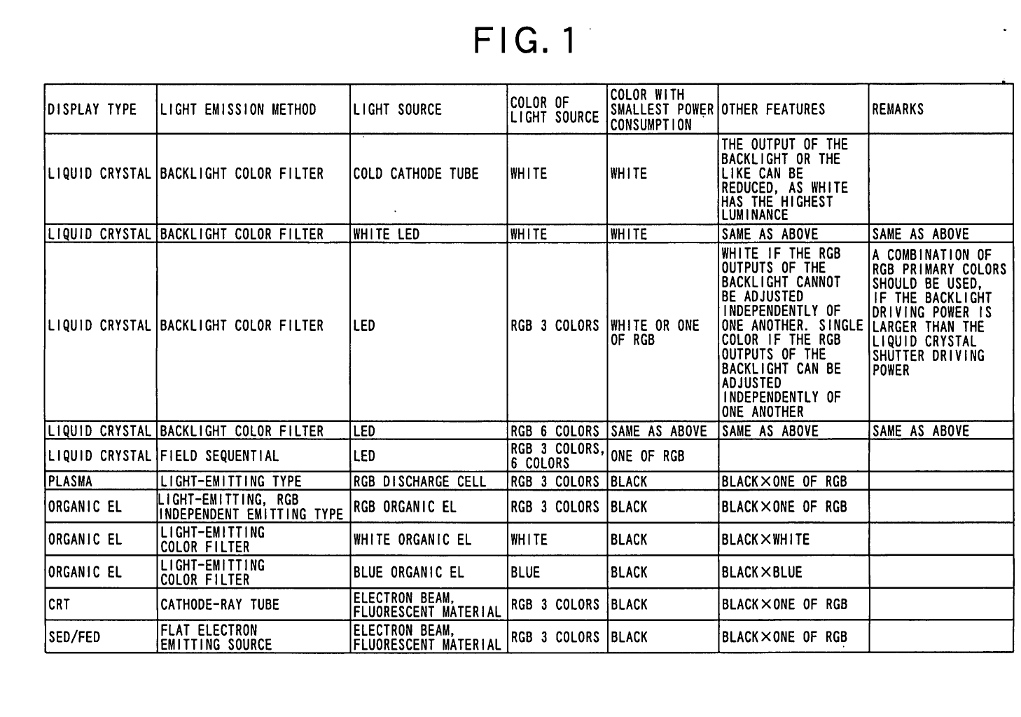

In the following, preferred embodiments of the present invention will be described in detail. Prior to the description of the preferred embodiments, the mechanism for achieving a power saving effect in a display operation by the invention is explained. FIG. 1 shows examples of power-saving techniques in various display types.

[I.1 Non-Emitting Type]

A display of a non-emitting type does not have the pixels of the display screen emitting light, but combines a light source such as a backlight or an external light source with a shutter function, so as to adjust the amount of light transmission. By doing so, the color of each of the pixels is controlled. Examples of such displays include liquid crystal displays.

A liquid crystal display is a display that shows an image by controlling the light emitted from a backlight, a front light, or an external light source, through liquid crystals. Liquid crystals characteristically deflect transmitted light, and, in combination with a deflecting plate, serve as a shutter that transmits light or shuts off light.

A light crystal display is formed from liquid crystals contained between two glass substrates having transparent electrodes, for example. A film for orienting liquid crystal molecules is formed on the surface of each glass substrate in contact with the liquid crystals. The deflecting plate is provided on the opposite-side surface of each glass substrate. In a case of a color liquid crystal display, a color filter of three primary colors for each pixel is provided on one of the glass substrates.

As the light source such as a backlight or a front light, a cold cathode tube, an LED (Light Emitting Diode), or the like is used to emit light constantly. While a voltage is not applied to the transparent electrodes, the liquid crystal molecules are oriented so as to transmit the light from the light source by virtue of the orienting film and the deflecting plate. When a voltage is applied to the transparent electrodes, the liquid crystal molecules are oriented in the direction of the voltage, so as to shut off the light from the light source.

In a liquid crystal display of a non-emitting type, the power consumption is minimized when a voltage is not applied to the transparent electrodes, and the color of the pixels in this situation is the light source color (the color of the light emitted from the light source). Therefore, to minimize the power consumption, the color of each pixel to be displayed is made to be the same as the light source color.

Since the light source color is normally white, the color of each pixel is also made white. Also, white is the color having the highest luminance, and provides excellent visibility. Therefore, the amount of power consumption can be made even smaller by reducing the light emission quantity of the light source.

If white is realized by forming the light source with a combination of LEDs of RGB three colors or six colors, and if the light emission of each of the LEDs can be controlled independently of the others, the color of each pixel may be one of the RGB three primary colors. In this manner, the number of LEDs to emit light can be reduced, and the power consumption can be further reduced.

In a liquid crystal display of a field sequential type, LEDs of RGB three colors (or six colors) are used as the light source, and high-speed on/off control is performed on each of the LEDs to emit light in repetitive order of RGB. The shutter formed of liquid crystals is then opened and closed in synchronization with the on/off control, so as to produce the color of each pixel by mixing colors over time.

By the above method, the color of each pixel to be displayed is one of the RGB three primary colors, and a voltage is not applied to the transparent electrodes (in other words, the light emitted from the LEDs is completely transmitted). Only the LED of one of RGB is caused to emit light, and the other LEDs do not emit light. Thus, the power consumption can be minimized.

[1.2 Light-Emitting Type]

A display of a light-emitting type is formed with light-emitting materials that have pixels emitting light. The light emission quantities of those light-emitting materials are adjusted to produce the color of each pixel. Examples of displays of the light-emitting type include plasma displays, organic EL displays, CRT displays, FEDs (Field Emission Displays), and SEDs (Surface-conduction Electron-emitter Displays).

A plasma display generates ultraviolet rays through gas discharge. The ultraviolet rays collide with each fluorescent material of RGB (an example of a light-emitting material of the present invention), so as to emit light and display an image.

In a plasma display, a partition wall is formed between two glass substrates having electrodes formed thereon, so as to produce a cell. A fluorescent agent is applied onto the cell, and a rare gas such as a mixed gas of neon and xenon is contained in the cell.

When a voltage is applied to the electrodes at both ends of the cell, discharge is caused in the cell, and ultraviolet rays are generated. The ultraviolet rays collide with the fluorescent materials, and the fluorescent materials emit light.

An organic EL display is a display that operates by virtue of a phenomenon called electro-luminescence.

An organic EL display has a light-emitting layer that is made of an organic substance (an example of a light-emitting material of the present invention) and is interposed between two electrodes of an anode and a cathode. A hole transporting layer is formed between the anode and the light-emitting layer, and an electron transporting layer is provided between the cathode and the light-emitting layer. To transmit the light of the light-emitting layer to the outside, either the anode or the cathode is a transparent electrode.

When a voltage is applied to the two electrodes, holes are injected from the anode, and electrons are injected from the cathode. The injected holes and electrons are transported through the transporting layers, and are combined in the light-emitting layer. At this point, the light-emitting layer is excited, but returns to the ground state. The energy generated by the light-emitting layer returning to the ground state is emitted as light.

The multicolor techniques utilized by organic EL displays include a technique of emitting three colors independently of one another, a technique of converting blue light to red and green light through a fluorescent converting film, and a technique of dividing white light into red light, green light, and blue light through a color filter.

In a CRT display, electrons emitted from an electron gun pass through holes formed in a shadow mask or the like, and collide with fluorescent materials (examples of light-emitting materials of the present invention) arranged in a three-color striped pattern or a dot pattern. Through the collision, the fluorescent materials emit light. The intensity of the current to be supplied to the electron gun is adjusted to change the intensity of the electron beam. By doing so, various colors can be produced. The electron beam is bent by a magnetic field generated by a deflecting yoke, and the magnetic field is changed so that the electron beam can be emitted on the entire screen.

Like a CRT display, a FED and a SED emit electrons from the cathode portions, and have the electrons colliding with fluorescent materials to emit light. However, unlike a CRT display, a FED and a SED have an electron emitter provided for each of the pixels.

A FED utilizes field electron emission, and has fluorescent materials of RGB three colors and a transparent electrode provided on the glass substrate on the front side. In a FED, a metal cone having a sharp edge called a “dip” is further provided on the glass substrate on the back side, and a gate electrode is formed to surround the metal cone.

When a voltage is applied to the gate electrode and the dip, electrons are emitted from the top edge of the dip. The electrons are accelerated by a voltage applied between the glass substrates, and collide with the fluorescent materials, to emit light.

In a SED, when a voltage is applied between slits formed by electron emitting films provided on the glass substrate on the back side, electrons are emitted by virtue of a tunneling effect. As in the case of a FED, the emitted electrons are accelerated by the voltage applied between the glass substrates, and collide with the fluorescent materials, to emit light.

The display techniques utilized in displays of light-emitting types have been described so far. In those displays, the power consumption is minimized when the light-emitting materials are not emitting light, or a voltage is not applied to the light-emitting materials, or a voltage is not applied to the electron emitter such as an electron gun. With the power consumption being minimized, the color of each pixel turns black. Accordingly, to minimize the power consumption, the color of each pixel to be displayed should be made black.

[1.3 Summary]

As described so far, the power consumption in a display of a non-emitting type is minimized when the color to be displayed is the color of the power source, while the power consumption in a display of a light-emitting type is minimized when the color to be displayed is black, as shown in FIG. 1.

Therefore, the color of the display element having the largest display area among the display elements (such as roads, buildings, backgrounds, guiding indicators, and the like) constituting an image of information (such as content data and image data) displayed on the screen of a display should be converted to such a color as to minimize the power consumption. By doing so, the power consumption can be made smaller than in a case where color conversion is not performed.

The power consumption can be further reduced by converting the colors of the display elements other than the display element having the largest display area to such colors as to reduce the power consumption (for example, colors similar to white in a display of a non-emitting type, and colors similar to black in a display of a light-emitting type).

Here, it is also preferable to convert the colors of the other display elements to such colors as to increase the visibility.

For example, the visibility can be increased by converting the colors of the other display elements to such colors as to increase the contrast ratio. As a result, the luminance of the entire image can be reduced. More specifically, in a display of a non-emitting type, the light emission quantity of the power source such as a backlight may be reduced. In a display of a light-emitting type, the voltage to be applied to the light-emitting materials or the electron emitter may be lowered.

The visibility can also be increased by combining the colors of the other display elements with complementary colors (such as a combination of red and blue green).

In a display of a light-emitting type, the number of light-emitting materials or electron emitters to which a voltage is applied can be reduced by converting the colors of the other display elements to one of RGB. Thus, the power consumption can be further reduced, without a decrease in visibility.

[2. First Embodiment]

Next, an embodiment in which the present invention is applied to a map information display system having map information displayed on a mobile terminal in accordance with information transmitted from a server is described.

[2.1 Structure and Functions of Map Information Display System S]

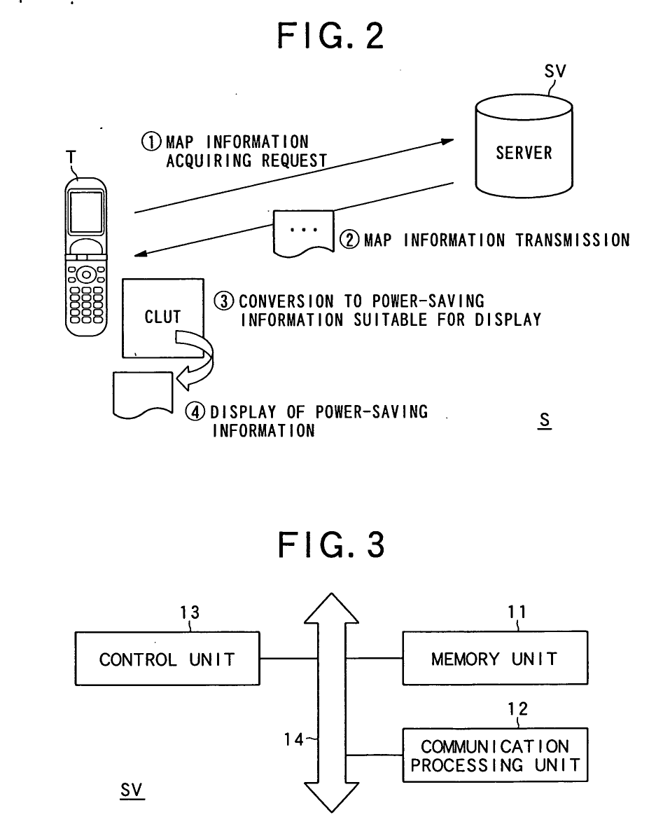

First, the structure and function of a map information display system S are described. FIG. 2 schematically shows an example structure of the map information display system S in accordance with a first embodiment.

As shown in FIG. 2, the map information display system S has a server SV and a mobile terminal T connected to a network.

The server SV and the mobile terminal T can exchange data via the network, for example, using TCP/IP (Transmission Control Protocol/Internet Protocol) for communication protocols. The network, for example, includes internet, mobile communication network or the like.

In this system, map information (an example of information in accordance with the present invention) containing HTML (Hyper Text Markup Language) text data and map image data is transmitted from the server SV to the mobile terminal T. In accordance with the type of the display provided in the mobile terminal T, the mobile terminal T converts the map information to such information as to reduce the power consumption by image display, and then displays the map information.

[2.2 Structure and Function of Server SV]

Next, the structure and function of the server SV are described. FIG. 3 is a block diagram schematically showing an example structure of the server SV in accordance with the first embodiment.

The server SV generates map information on the basis of a map information acquiring request that is transmitted from the mobile terminal T, and transmits the map information to the mobile terminal T.

As shown in FIG. 3, the server SV includes a memory unit (such as a hard disk) 11 that stores various programs and data, a communication processing unit (such as a network adaptor) 12 that is connected to the network and controls the state of communication with the mobile terminal T, and a control unit 13 that has a CPU (Central Processing Unit), a RAM (Random Access Memory), a ROM (Read Only Memory), and the like. The memory unit 11, the communication processing unit 12, and the control unit 13 are connected to one another via a system bus 14.

The memory unit 11 contains information as to positions on a map represented by latitudes and longitudes, and a map DB (database) having map image data recorded therein in accordance with the position information.

The control unit 13 has the CPU reading and executing the various programs stored in the ROM or the memory unit 11, so as to collectively control the components of the server SV.

The various programs and the like may be downloaded from another server, or may be read in from a recording medium such as a CD-ROM via a drive.

[2.3 Structure and Function of Mobile Terminal T]

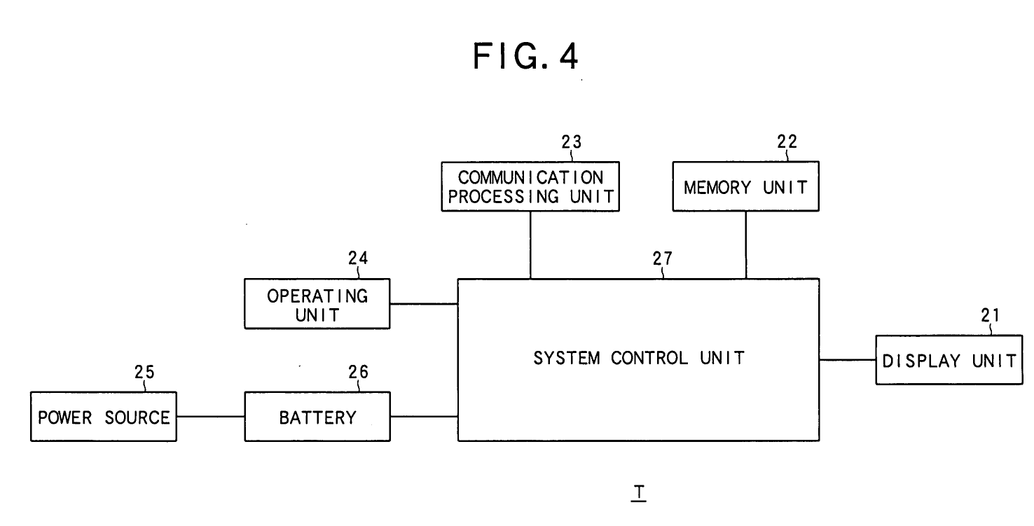

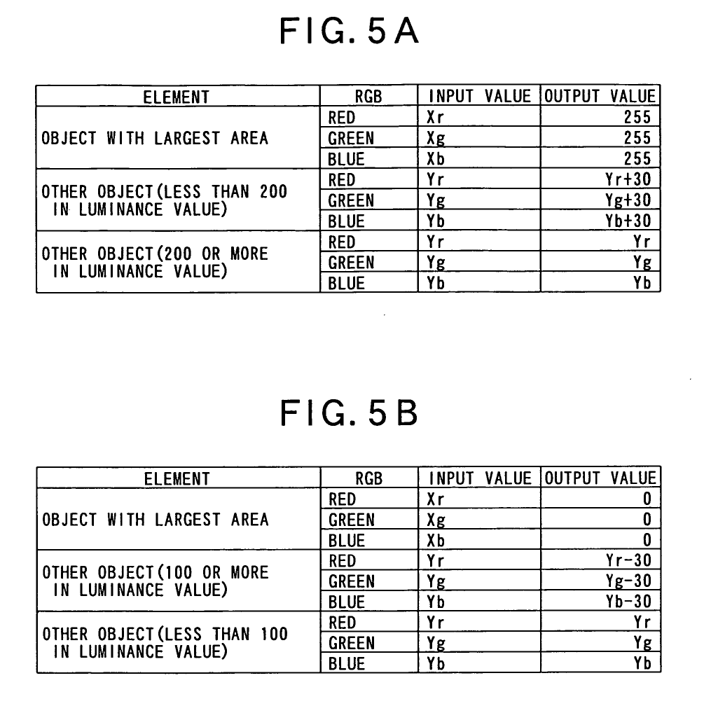

Next, the structure and function of the mobile terminal T are described. FIG. 4 is a block diagram schematically showing an example structure of the mobile terminal T in accordance with the first embodiment. FIGS. 5A and 5B show an example of a CLUT.

The mobile terminal T transmits the map information acquiring request to the server SV, and converts the map image data contained in the map information transmitted from the server SV on the basis of a CLUT (Color Look-Up Table) in accordance with the type of the display provided in the mobile terminal T. The converted map image is then displayed.

The mobile terminal T may be a portable telephone device, a PDA (Personal Digital Assistant), a portable car navigation apparatus, or the like.

As shown in FIG. 4, the mobile terminal T includes: a display unit 21 that displays information such as texts and images; a memory unit 22 that stores various programs and data; a communication processing unit 23 that is connected to the network and controls the state of communication with the server SV; an operating unit 24 (such as operating buttons) for receiving operating instructions from users and outputting the contents of the instructions to a system control unit 27; a power source 25 that is detachably connected to the main body of the mobile terminal T, converts AC power supplied from a commercial power source to DC power, and supplies the DC power to a battery 26; the battery 26 that stores the power supplied from the power source 25 and supplies the stored power to each component; and the system control unit 27 that includes a CPU (Central Processing Unit), a RAM (Random Access Memory), a ROM (Read Only Memory), and the like.

The display unit 21 as a display device is formed with a display panel such as a liquid crystal display or a plasma display, a buffer memory, a graphic controller, and the like. In predetermined timing, the graphic controller reads image data that is input to the buffer memory under the control of the system control unit 27. The image data is displayed on the screen of the display.

The memory unit 22 is formed with, for example, a non-volatile memory, a hard disk, or the like. The memory unit 22 stores the CLUT to be used for converting the color of each of the objects that is contained in the map image data received by the system control unit 27 and constitutes an image to be displayed on the screen in accordance with the display technique utilized by the display unit 21. The object is an example of the display element according to the invention and includes road, building, and ground or the like.

As shown in FIG. 5, the input values and the output values of RGB with respect to the object with the largest area and the other objects are associated with each other and stored in the CLUT.

The color of each object is represented by a luminance value between 0 and 255 for each of RGB. If all the RGB values are 0, the color is black. If all the RGB values are 255, the color is white.

The input values are the luminance values of the RGB primary colors of the objects, and the output values are the luminance values of the RGB of the colors after conversion.

For example, in a case where a liquid crystal display of a cathode-tube backlight color filter type that is of a non-emitting type is employed as the display unit 21, the luminance value of 255 is set for all the output values of the luminance values Xr, Xg, and Xb for the RGB of the object with the largest display area, as shown in FIG. 5A. Accordingly, the color of the object with the largest area is white, which consumes least power through a display operation with the liquid crystal display.

Meanwhile, in a case where the luminance values Yr, Yg, and Yb of the RGB of another object are the input values, the luminance values each having 30 added to the original luminance value are set as the output values in the CLUT. In this manner, such a color as to reduce the power consumption through a display operation with the liquid crystal display can be set for another object. If the luminance value after the addition is 255 or larger, the upper limit of 255 should be set for the luminance value.

However, in a case where the original luminance values Yr, Yg, and Yb are 200 or larger, the original luminance values are set as the output values. This is because the power consumption through a display operation with the liquid crystal display is small if the original color is a light color, and there is no need to further increase the luminance. This is also because the color of the object with the largest area is white, and therefore, it is preferable not to increase the luminance in terms of visibility.

In a case where an organic EL display of a RGB independent emitting type that is of a light-emitting type, for example, is employed as the display unit 21, the luminance value of 0 is set for all the output values of the luminance values Xr, Xg, and Xb of the RGB of the object with the largest area, as shown in FIG. 5B. Accordingly, the color of the object with the largest area is black, which consumes least power through a display operation with the organic EL display.

Meanwhile, in a case where the luminance values Yr, Yg, and Yb of the RGB of another object are the input values, the luminance values each having 30 subtracted from the original luminance value are set as the output values in the CLUT. In this manner, such a color as to reduce the power consumption through a display operation with the organic EL display can be set for another object. If the luminance value after the subtraction is 0 or less, the lower limit of 0 should be set for the luminance value.

However, in a case where the original luminance values Yr, Yg, and Yb are all 100 or smaller, the original luminance values are set as the output values.

Instead of the CLUT, for example, a program having an interface with the above-described inputs and outputs may be used.

The system control unit 27 has the CPU reading and executing the various programs stored in the ROM or the memory unit 22, so as to collectively control each component of the server SV. The system control unit 27 also executes a map information display program, so as to function as a color converting device, a display control device, a light source adjusting device, and the like.

The CLUT, the map information display program, and the like may be downloaded from the server SV, or may be read in from a recording medium such as a CD-ROM via a drive.

[2.4 Operation of Map Information Display System S]

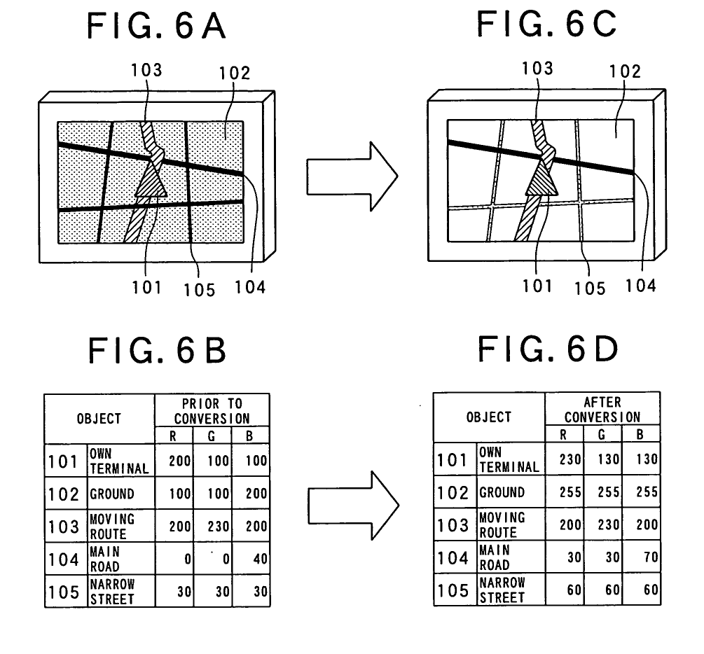

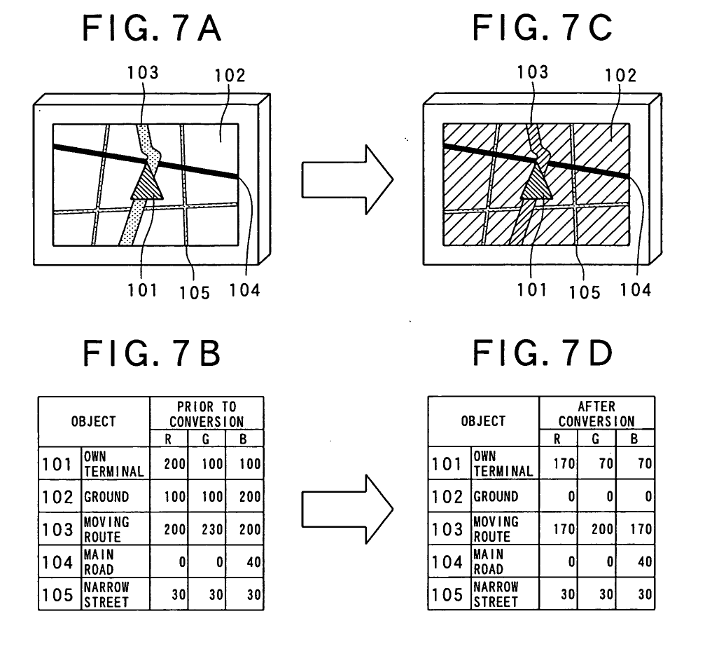

The operation of the map information display system S having the above-described structure is now described. FIGS. 6A through 6D illustrate a situation in which the color of each object in map image data is converted in a display of a non-emitting type. FIG. 6A shows the map image data prior to conversion. FIG. 6B shows the luminance values of the RGB of each object prior to conversion. FIG. 6C shows the map image data after conversion. FIG. 6D shows the luminance values of the RGB of each object after conversion. FIGS. 7A through 7D illustrate a situation in which the color of each object in map image data is converted in a display of a light-emitting type. FIG. 7A shows the map image data prior to conversion. FIG. 7B shows the luminance values of the RGB of each object prior to conversion. FIG. 7C shows the map image data after conversion. FIG. 7D shows the luminance values of the RGB of each object after conversion.

First, the system control unit 27 of the mobile terminal T controls the communication processing unit 23, so as to transmit a map information acquiring request containing position information that is input from the user via the operating unit 24, to the server SV.

In a case where a liquid crystal display is employed for the display unit 21, the system control unit 27 controls the display unit 21 to reduce the light quantity of the backlight of the liquid crystal display. More specifically, the colors of the map information data are to be converted into lighter colors through a later described operation of converting the map image data. Therefore, the light quantity of the backlight is reduced, so as to reduce the power consumption of the liquid display without a decrease in visibility.

The control unit 13 of the server SV receives the map information acquiring request, which is transmitted from the mobile terminal T, via the communication processing unit 12. On the basis of the position information contained in this request, the control unit 13 acquires the corresponding map image data from the map DB of the memory unit 11. The control unit 13 then generates HTML text data containing tag information for displaying the map data. The control unit 13 controls the communication processing unit 12 so as to transmit the map information containing the HTML text data to the mobile terminal T.

The system control unit 27 of the mobile terminal T receives the map information transmitted from the server SV via the communication processing unit 23, and stores the map information in the RAM.

With the map image data containing an image of a range to be displayed on the screen of the display unit 21, the system control unit 27 calculates the display area of each object contained in the image in a predetermined range that might be displayed in the future, and determines the object with the largest display area.

For example, in a case where the ground occupies the largest display area in a predetermined wide range but roads occupies the largest display area in a partial range full of roads to be displayed on the screen, the object having the largest display area is detected only in the range to be displayed on the screen, and the color of the roads as the object is converted to such a color as to minimize the power consumption. In doing so, there is a higher possibility that a wider area of ground can be displayed when the map image data and a part of the map image data is displayed on the screen. This does not reduce the power consumption in total. To prevent this, the object having the largest display area is detected in the range to be displayed on the screen every time map image data is displayed. When conversion is performed, the roads that have been shown in natural colors are suddenly displayed in different colors. As a result, blinking is caused on the screen, and the visibility deteriorates.

In this embodiment to counter those problems, the object having the largest display area is detected not only in the range to be displayed on the screen but also in a predetermined range including the screen that might be displayed in the future. If the above-described inconvenience does exist, the object having the largest display area may be detected only in the range to be displayed on the screen.

The system control unit 27 performs the operation of converting map image data, referring to the CLUT. An example of this operation is described below in detail, with reference to the drawings.

FIG. 6A shows the map image data transmitted from the server SV. This data contains the objects of own terminal 101, a ground 102, a moving route 103, a principal road 104, and a narrow street 105. The luminance values of the RGB of each of the objects are shown in FIG. 6B. In this example, the ground 102 has the largest display area.

In the case where a liquid crystal display is employed for the display unit 21, all the luminance values of the ground 102, which is the object having the largest display area, are converted to 255. Since each of the luminance values of the moving route 103 is 200 or larger, the luminance values after the conversion are the same as those before the conversion. Each of the luminance values of the own terminal 101, the principal road 104, and the narrow street 105 is converted to a value having 30 added to the unconverted luminance value.

After the map image data is converted in this manner, the system control unit 27 sets the converted map image data in the buffer memory of the display unit 21. An example of the display is shown in FIG. 6C.

In a case where an organic EL display is employed for the display unit 21, all the luminance values of the ground 102 are converted too, as shown in FIG. 7D. Since each of the luminance values of the principal road 104 and the narrow street 105 is less than 100, the luminance values after the conversion are the same as those before the conversion. Each of the luminance values of the own terminal position and the moving route 103 is converted to a value having 30 added to the unconverted luminance value. As a result, the displayed map image data is shown as FIG. 7C.

As described above, in accordance with this embodiment, in a case where a display of a non-emitting type such as a liquid crystal display is employed for the display unit 21, the system control unit 27 of the mobile terminal T converts the object having the largest display area among the objects constituting the image of the map image data displayed on the screen of the display unit 21, to white. The converted map image data is then displayed by the display unit 21. In a case where a display of a light-emitting type such as an organic EL display is employed for the display unit 21, the system control unit 27 of the mobile terminal T converts the object having the largest display area in a predetermined image range including the screen among the objects constituting the image of the map image data displayed on the screen of the display unit 21, to black. The converted map image data is then displayed by the display unit 21.

In this manner, the color of the object having the largest display area is converted to such a color as to minimize the power consumption by the display operation, in accordance with the display technique employed in the display unit 21. Thus, the power consumption by the display operation can be reduced in accordance with each of various display techniques.

Further, the color of the object having the largest display area in the image range of the map image data that contains the image of the map image data currently displayed on the screen and might be displayed in the future is converted to such a color as to minimize the power consumption. Accordingly, the power consumption by the display operation can be reduced even in a case where the map image data is displayed with the display positions being varied with time.

Further, it is possible to cope with various display techniques simply by changing the CLUT. Accordingly, there is not need to design a power-saving hardware for each display.

Furthermore, in a case where a liquid crystal display is employed for the display unit 21, the system control unit 27 converts the color of the object having the largest display area to white. When the converted map image data is displayed on the display unit 21, the system control unit 27 reduces the light quantity of the backlight of the liquid crystal display. Thus, the power consumption can be further reduced, without a decrease in visibility.

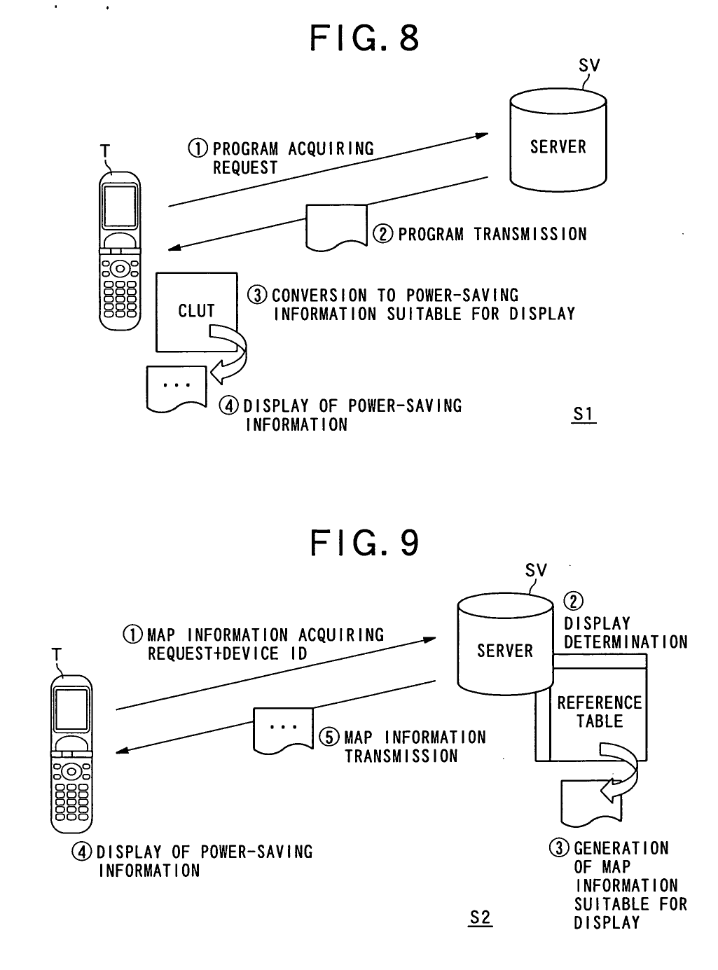

Although the map image data transmitted from the server SV is converted and displayed in the mobile terminal T in this embodiment, but the present invention is not limited to this. For example, in a map information display system S1 shown in FIG. 8, a program for generating and displaying map image data may be stored in the server SV, and the mobile terminal T may execute the program transmitted from the server SV in response to a program acquiring request from the mobile terminal T. By doing so, the map image data is generated, and the generated image data is converted with reference to the CLUT. The converted data is then displayed.

Also, the CLUT is designed so that addition or subtraction is collectively performed on all the luminance values of each set of RGB in this embodiment. However, the CLUT may be designed so that addition or subtraction may be performed on the luminance values independently of one another (for example, “30 ” is added only to the luminance value of the color of less than 200 in luminance).

[3. Second Embodiment]

[3.1 Structure and Function of Map Information Display System S2]

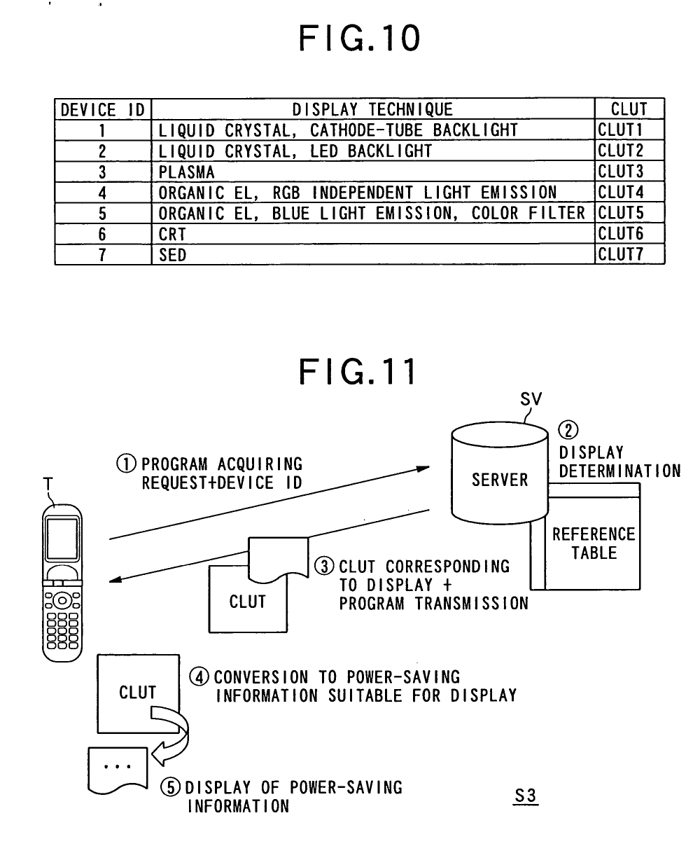

Next, a second embodiment of the present invention is described. FIG. 9 schematically illustrates an example structure of a map information display system S2 in accordance with the second embodiment. FIG. 10 shows an example of a reference table.

In the first embodiment, map image data is converted to power-saving map image data in the mobile terminal T. In this embodiment, on the other hand, the server SV converts map image data to such map information as to reduce the power consumption in an image display operation, in accordance with the display technique utilized by the mobile terminal T, as shown in FIG. 9. The converted map information is transmitted to the mobile terminal T, and is displayed on the mobile terminal T.

The fundamental structure of the map information display system S2 and the structures of the server SV and the mobile terminal T are basically the same as those of the first embodiment. Therefore, only the different aspects from the first embodiment are described below.

The server SV converts map image data, using the CLUT corresponding to the device ID (an example of method information in accordance with the present invention) indicating the display technique utilized by the display unit 21 of the mobile terminal T, and transmits the converted map image data to the mobile terminal T.

The reference table for determining the CLUT corresponding to the display technique utilized by the mobile terminal T is stored in the memory unit 11. As shown in FIG. 10, CLUTs that are associated with device IDs in accordance with display techniques are set in the reference table.

Although seven different devices IDs are allotted to seven different display techniques in FIG. 8, the number of display techniques may be increased or reduced. For example, only a non-emitting type and a light-emitting type may be employed. Also, a device ID may be allotted to each type of the mobile terminal T.

The control unit 13 as a receiving device, a color converting device, and a transmitting device, receives the position information and the device ID transmitted from the mobile terminal T, and generates map image data and HTML text data. The control unit 13 then performs the same converting operation as that in the first embodiment, using the CLUT corresponding to the device ID, with reference to the reference table. The control unit 13 then transmits map information containing the converted map image data and HTML text data to the mobile terminal T.

The mobile terminal T transmits the device ID of the display unit 21 to the server SV, and displays the power-saving map information converted by the server SV.

The system control unit 27 as a transmitting device, a receiving device, and a display control device, refers to display information obtained from the display unit 21 or display information recorded beforehand in the ROM, so as to acquire the device ID, and transmits the device ID to the server SV. The system control unit 27 receives the map information transmitted from the server SV, and causes the display unit 21 to display the map information.

[3.2 Operation of Map Information Display System S2]

Next, the operation of the map information display system S2 is described.

First, the system control unit 27 of the mobile terminal T obtains the device ID of the display unit 21. If the display unit 21 is an organic EL display of a RGB independent emitting type, the system control unit 27 acquires “4” as the device ID.

The system control unit 27 controls the communication processing unit 23 to transmit a map information acquiring request containing the position information input from the user via the operating unit 24 and the acquired device ID to the server SV.

The control unit 13 of the server SV receives the map information acquiring request transmitted from the mobile terminal T via the communication processing unit 12. On the basis of the position information contained in this request, the control unit 13 acquires the corresponding map image data from the map DB of the memory unit 11, and generates HTML text data containing tag information for displaying the map data.

The control unit 13 then obtains the CLUT corresponding to the device ID contained in the map information acquiring request from the memory unit 11 (for example, the CLUT shown in FIG. 4B in the case of an organic EL display of a RGB independent emitting type).

Like the mobile terminal T of the first embodiment, the control unit 13 determines which object has the largest display area, and performs the operation of converting the map image data, referring to the obtained CLUT.

The control unit 13 then controls the communication processing unit 12 to transmit map information containing the converted map image data to the mobile terminal T.

The system control unit 27 of the mobile terminal T receives the map information transmitted from the server SV via the communication processing unit 23, and the map image data converted to power-saving data by the server SV is displayed on the display unit 21.

As described above, in accordance with this embodiment, the mobile terminal T transmits the device ID indicating the display technique to the server SV. Upon receipt of this device ID, the server SV converts the color of the object having the largest display area among the objects constituting the image displayed on the screen of the display unit 21 of the mobile terminal T on the basis of the map image data stored in the memory unit 11, to such a color as to minimize the power consumption in the display operation in accordance with the display technique represented by the device ID. The server SV transmits map information containing the converted map image data to the mobile terminal T. The mobile terminal T receives and displays the map information.

As in the first embodiment, the power consumption in the display operation can be reduced in accordance with each of various display techniques in this embodiment.

[3.3 Modification]

Next, a modification of the second embodiment is described. FIG. 11 schematically illustrates an example structure of a map information display system S3 in accordance with a modification of the second embodiment.

Although map image data is converted in the server SV in the second embodiment, the present invention is not limited to that. For example, map image data may be converted in the mobile terminal T, as shown in FIG. 11.

More specifically, CLUTs corresponding to various display techniques are stored, and a map information display program for displaying map image information by controlling the operation of the mobile terminal T are stored in the server SV.

The mobile terminal T transmits a program acquiring request containing a device ID to the server SV.

Upon receipt of the program acquiring request, the server SV obtains the CLUT corresponding to the device ID contained in this request.

The server SV transmits the obtained CLUT and the predetermined map information display program to the mobile terminal T.

After receiving the CLUT and the map information display program, the mobile terminal T executes this program to generate map image data, and performs the operation of converting the map image data to power-saving image data, referring to the CLUT. The converted image data is then displayed.

In this manner, in this modification, the power consumption in the display operation can also be reduced in accordance with the display technique.

It is also possible to transmit the map information display program suitable for the display technique utilized in the mobile terminal T, instead of the CLUT corresponding to the display technique utilized in the mobile terminal T and the predetermined map information display program.

[4. Third Embodiment]

Next, an embodiment in which the present invention is applied to a mobile terminal for displaying map information is described.

In the first and second embodiments, the map information to be displayed and the map information display program are transmitted from the server SV. In this embodiment, on the other hand, a map information display program is installed beforehand in the mobile terminal T, and map information is generated in the mobile terminal T.

In this embodiment, the display contents are simplified, so as to further reduce the power consumption in the display operation.

In this embodiment, the mobile terminal T operates in two modes: a normal mode for displaying regular map image data; and a power-saving mode for displaying map image data converted for power saving.

[4.1 Structure and Functions of Mobile Terminal T]

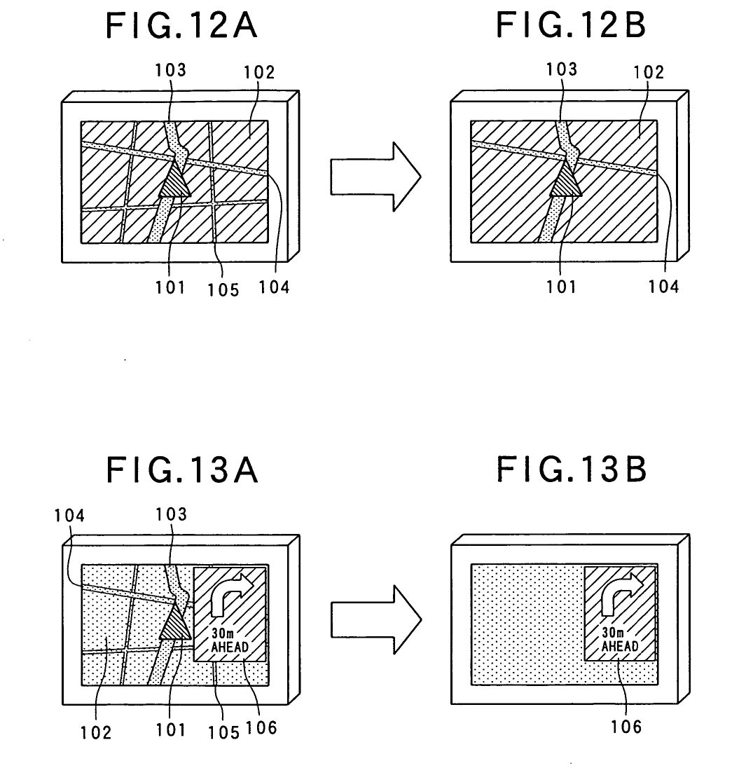

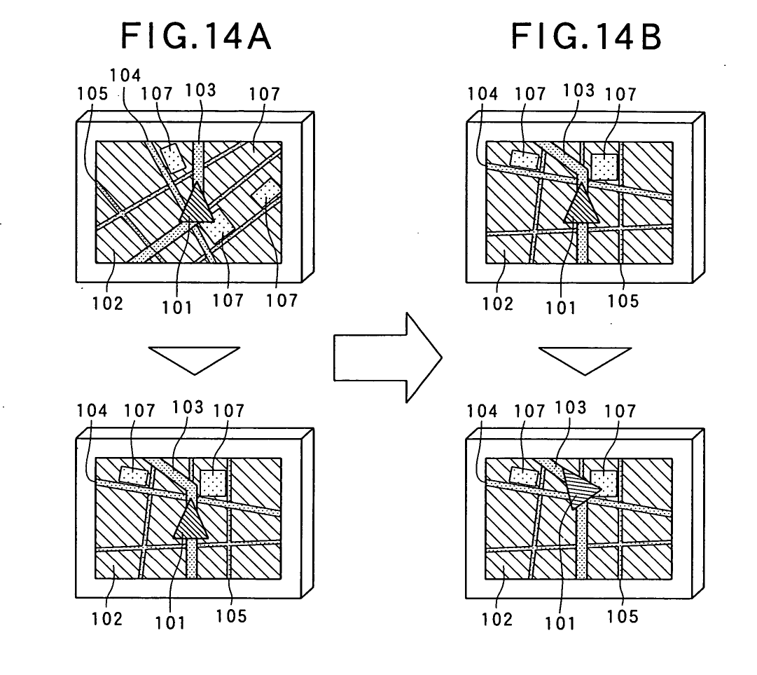

Next, the structure and functions of the mobile terminal T are described. The structure of the mobile terminal T of this embodiment is basically the same as that of the first embodiment, and therefore, only the different aspects from the mobile terminal T of the first embodiment are described below. FIGS. 12A and 12B illustrate an example of a display simplifying process. FIG. 12A shows a specific display, and FIG. 12B shows a simpler display. FIGS. 13A and 13B illustrate another example of a display simplifying process. FIG. 13A shows a guiding display formed with a map and a guiding arrow. FIG. 13B shows a preliminary guiding display formed only with a guiding arrow. FIGS. 14A and 14B illustrate yet another example of a display simplifying process. FIG. 14A shows a head-top display. FIG. 14B shows a north-top display.

The map information display program and the CLUT corresponding to the display technique utilized by the display unit 21 are stored in the memory unit 22 of the mobile terminal T.

Also, data for generating map image data, such as road data and architecture data, are associated with the position information represented by the latitudes and longitudes of positions, and are stored in the memory unit 22.

Under the control of the system control unit 27, the battery 26 outputs a signal indicating the amount of currently remaining power and a signal indicating whether the battery 26 is currently being charged (whether the power source 25 is connected to the battery 26) to the system control unit 27.

On the basis of the input signal indicating the amount of currently remaining power and the input signal indicating whether the battery 26 is being charged, the system control unit 27 determines whether the mobile terminal T is to operate in the normal mode or the power-saving mode.

In a case where there is a sufficient amount of remaining power in the battery 26, for example, the mobile terminal T operates in the normal mode. In a case where there is only a small amount of remaining power (for example, if the amount of remaining power is 10% or less of the full amount), the mobile terminal T operates in the power-saving mode. In a case where the battery 26 is being currently charged, the mobile terminal T operates in the normal mode, regardless of the amount of remaining power.

The system control unit 27 determines in which mode the mobile terminal T is to operate, in accordance with a power-saving mode setting/canceling instruction that is input by the user via the operating unit 24.

If the power-saving mode is set, for example, the mobile terminal T operates in the power-saving mode, regardless of the amount of remaining power and whether the battery 26 is being charged. If the power-saving mode is canceled, the mobile terminal T operates in accordance with the amount of remaining power and whether the battery 26 is being charged.

When the mobile terminal T operates in the power-saving mode, the system control unit 27 controls the display state or non-display state and the display type of each object to be contained in the map image data, and generates simplified map image data.

For example, in the normal mode, a specific display showing all the objects is displayed, as shown in FIG. 12A. In the power-saving mode, the narrow street 105 with the lowest priority level is not shown in the simplified display, as shown in FIG. 12B.

In this example, one of the display elements other than the object having the largest display area is eliminated from the components of the image, so that the area of the color to minimize the power consumption in the display operation becomes larger and the power consumption decreases. Also, the principal road 104 may not be displayed, and only the own terminal 101, the ground 102, and the moving route 103 may be displayed.

In another example case, in the normal mode, all the objects of map image data and a guiding arrow 106 are displayed, as shown in FIG. 13A. In the power-saving mode, only the guiding arrow 106 is displayed, and the background is shown in such a color as to minimize the power consumption in the display operation (the light-source color in the case of a non-emitting type, black in the case of a light-emitting type), as shown in FIG. 13B.

In this example case, the object to be displayed is selected so as to increase the area of the color to minimize the power consumption in the display operation. Thus, the total power consumption is reduced.

In yet another example case, in the normal mode, the position of the own terminal 101 is fixed at the center, and the traveling direction is indicated by an upward arrow on the screen, as shown in FIG. 14A. In this case, the map (including the objects such as the principal road 104, the narrow street 105, and a building 107) is moved or rotated in synchronization with the movement of the own terminal 101. This is a so-called head-top display. In the power-saving mode, as shown in FIG. 14B, the map is fixed, with the top of the image pointing north, and the own terminal 101 is moved or rotated. This is a so-called north-top display.

In this example case, the amount of movement on the screen is reduced, so as to reduce the total number of liquid crystals and light-emitting materials to which varied voltages are applied. As a result, the power consumption is reduced.

In the above-described three examples, the display contents are simplified, so as to reduce the amount of calculation to be performed by the system control unit 27. Accordingly, the power consumption of the CPU is also reduced.

Each of the above examples may be employed independently of the others, or may be utilized in combination with another example.

[4.2 Operation of Mobile Terminal T]

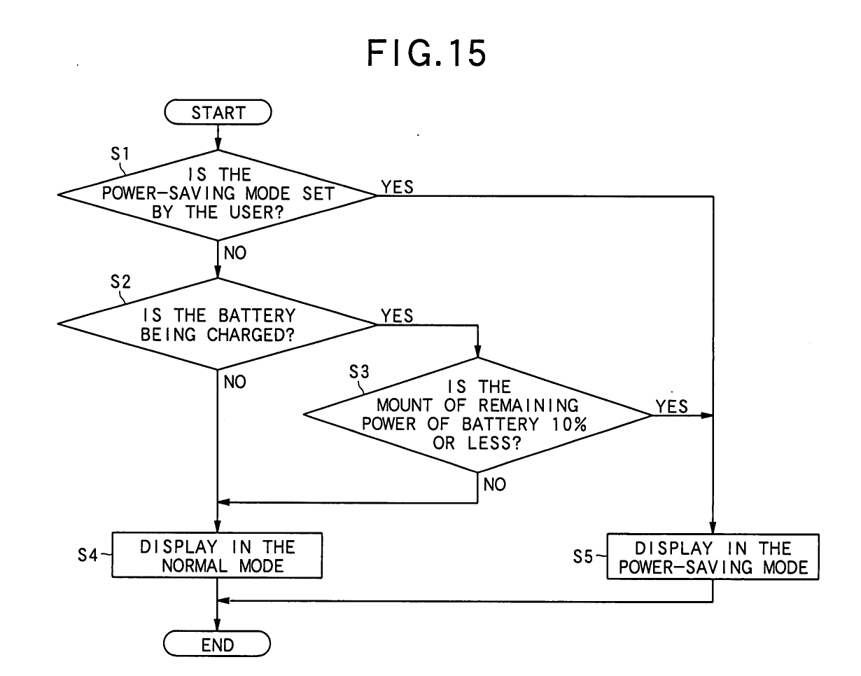

Next, the operation of the mobile terminal T is described. FIG. 15 is a flowchart showing an example of the operation to be performed by the system control unit 27 of the mobile terminal T in accordance with the third embodiment.

As shown in FIG. 15, the system control unit 27 first determines whether the power-saving mode is set by the user (step S1). If the power-saving mode is set (“YES” in step S1), the operation moves on to a power-saving mode display (step S5). If the power-saving mode is not set (“NO” in step S1), the operation moves on to step S2.

In step S2, the system control unit 27 determines whether the battery 26 is being currently charged. If the battery 26 is being charged (“YES” in step S2), the operation moves on to a normal mode display (step S4). If the battery 26 is not being charged (“NO” in step S2), the operation moves on to step S3.

In step S3, the system control unit 27 determines whether the amount of remaining power is 10% or less of the full power amount. If it is 10% or less (“YES” in step S3), the operation moves on to the power-saving mode display (step S5). If it is more than 10% (“NO” in step S3), the operation moves on to the normal mode display (step S4).

In the normal mode, the system control unit 27 does not simplify the display contents, and does not convert map image data either. Instead, the system control unit 27 generates and displays map image data (step S4).

In the power-saving mode, the system control unit 27 simplifies the display contents and converts map image data. The system control unit 27 then generates and display the map image data (step S5).

More specifically, the object having the largest display area is detected from the objects constituting the image in the predetermined range including the range of the map image data to be displayed on the screen of the display unit 21.

The system control unit 27 eliminates an object such as the narrow street 105, which is not the object having the largest display area, from the objects constituting the image to be displayed, and generates such map image data that can be displayed in a north-top fashion.

As in the first embodiment, the system control unit 27 performs the operation of converting the map image data, referring to the CLUT, and causes the display unit 21 to display the converted map image data.

In a case where a guiding display is formed with a guiding arrow 106, the system control unit 27 selects the guiding arrow 106 as a display object. After generating map image data only with the guiding arrow 106, the system control unit 27 converts the color of the region in which the guiding arrow 106 is not to be displayed, to such a color as to minimize the power consumption in accordance with the display technique utilized by the display unit 21.

As described above, in this embodiment, the power consumption in the display operation can be reduced in accordance with various display techniques, as in the first embodiment.

Since at least one of the objects other than the object having the largest display area is eliminated from the objects constituting the image to be displayed on the screen of the display unit 21, the area in which such a color as to minimize the power consumption is displayed can be increased. Thus, the amount of power consumption can be made even smaller.

Also, the guiding arrow 106 is selected as a display object, and the color of the image in the region in which the guiding arrow 106 is not to be displayed is converted to such a color as to minimize the power consumption in the display operation on the screen of the display unit 21, in accordance with the display technique utilized by the display unit 21. Accordingly, the area in which the color to minimize the power consumption is displayed is increased. Thus, the amount of power consumption can be made even smaller.

Furthermore, map image data is generated in a north-top fashion. Accordingly, the amount of display movement per unit time is reduced, and the total number of liquid crystals and light-emitting materials to which varied voltages are to be applied is reduced. Thus, the amount of power consumption can be made even smaller.

Although a mobile terminal is used as the display apparatus in each of the above-described embodiments, the present invention is not limited to that. For example, the display apparatus may be a desktop personal computer, a digital television set, a STB (Set Top Box), or the like.

In each of the above-described embodiments, the present invention is applied to a map information display system or a map information display program. However, it is also possible to apply the present invention to systems such as a content distribution system and an application distribution system, and various applications such as video games.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2005-307359 filed on Oct. 21, 2005 including the specification, claims, drawings and abstract is incorporated herein by reference in its entirety.

What is claimed is:

1. A display apparatus that has a display device which displays information on a screen, comprising:
a color converting device which converts a color of a display element having the largest display area among display elements constituting an image of the information displayed on the screen, to such a color as to minimize power consumption in the display operation, in accordance with a display technique utilized by the display device; and
a display control device which causes the display device to display the information after the conversion.

2. The display apparatus according to claim 1,
wherein the color converting device converts the color of the display element having the largest display area in an image range of the information that contains the image of the information currently displayed on the screen and has a possibility of future display operation, to such a color as to minimize the power consumption through the display operation, in accordance with the display technique utilized by the display device.

3. The display apparatus according to claim 1,
wherein the color converting device converts the color of the display element having the largest display area to a color of the light, when the display technique involves adjusting the amount of transmission of light emitted from a light source for each of pixels of the screen and displaying a color of each of the pixels.

4. The display apparatus according to claim 3, further comprising
a light source adjusting device which reduces the light quantity of the light source, when the display control device causes the display device to display the information after the conversion.

5. The display apparatus according to claim 1,
wherein the color converting device converts the color of the display element having the largest display area to black, when the display technique involves adjusting the light quantity of light-emitting materials corresponding to pixels of the screen and displaying the color of each of the pixels.

6. The display apparatus according to claim 1, further comprising
an eliminating device which eliminates at least one display element other than the display element having the largest display area from the display elements constituting the image to be displayed on the screen.

7. The display apparatus according to claim 1, further comprising
a selecting device which selects the display element to be displayed on the screen,
wherein the color converting device converts a color of an image in a range not having the selected display element displayed therein, to such a color as to minimize power consumption through the display operation on the screen, in accordance with the display technique utilized by the display device.

8. A recording medium which has a program recorded therein in such a manner that a computer contained in the display apparatus according to claim 1 can read the program,
the program causing the computer to function as the color converting device and the display control device.

9. A display method which is utilized in a display apparatus including a display device that displays information on a screen,
the display method comprising:
a process of converting a color of a display element having the largest display area among display elements constituting an image of the information displayed on the screen, to such a color as to minimize power consumption in the display operation, in accordance with a display technique utilized by the display device; and
a process of causing the display device to display the information after the conversion.

10. A display system comprising:
a display apparatus which includes a display device which displays information on a screen; and
a server which can be connected to the display apparatus via a network,
the server including:
a receiving device which receives technique information indicating a display technique utilized by the display device, the technique information being transmitted from the display apparatus;
a color converting device which converts a color of a display element having the largest display area among display elements constituting an image of the information displayed on the screen, to such a color as to minimize power consumption in the display operation, in accordance with the display technique utilized by the display device; and
a transmitting device which transmits the information after the conversion to the display apparatus,
the display apparatus including:
a transmitting device which transmits the technique information to the server;
a receiving device which receives information transmitted from the server; and
a display control device which causes the display device to display the received information.

11. The display apparatus of the display system according to claim 10, comprising the display device, the transmitting device, the receiving device, and the display control device.

12. A recording medium which has a program recorded therein in such a manner that a computer contained in the display apparatus according to claim 11 can read the program,
the program causing the computer to function as the transmitting device, the receiving device, and the display control device.

13. The server of the display system according to claim 10, comprising the receiving device, the color converting device, and the transmitting device.

14. A recording medium which has a program recorded therein in such a manner that a computer contained in the server according to claim 13 can read the program,
the program causing the computer to function as the receiving device, the color converting device, and the transmitting device.

15. A display method which is utilized in a display system which includes a display apparatus and a server, the display apparatus having a display device which displays information on a screen, and the server being connectable to the display apparatus via a network,
the display method comprising:
a process of the display apparatus transmitting technique information indicating a display technique utilized by the display device to the server;
a process of the server receiving the technique information transmitted from the display apparatus;
a process of the server converting a color of a display element having the largest display area among display elements constituting an image of the information displayed on the screen, to such a color as to minimize power consumption in the display operation, in accordance with the display technique utilized by the display device;
a process of the server transmitting the information after the conversion to the display apparatus;
a process of the display apparatus receiving information transmitted from the server; and
a process of the display apparatus causing the display device to display the received information.

16. A display system comprising:
a display apparatus which includes a display device which displays information on a screen; and
a server which can be connected to the display apparatus via a network,
the server including:
a receiving device which receives technique information indicating a display technique utilized by the display device, the technique information being transmitted from the display apparatus; and
a transmitting device which transmits a program in accordance with the received technique information to the display apparatus, the program being used for controlling an operation of the display apparatus,
the display apparatus including:
a transmitting device which transmits the technique information to the server;
a receiving device which receives the program transmitted from the server;
a color converting device which converts a color of a display element having the largest display area among display elements constituting an image of the information displayed on the screen under control of the received program, to such a color as to minimize power consumption in the display operation, in accordance with the display technique utilized by the display device under control of the received program; and
a display control device which causes the display device to display the converted information under control of the received program.

17. The display apparatus of the display system according to claim 16, comprising the display device, the transmitting device, the receiving device, the color converting device, and the display control device.

18. A recording medium which has a program recorded therein in such a manner that a computer contained in the display apparatus according to claim 17 can read the program,
the program causing the computer to function as the color converting device and the display control device.

19. The server of the display system according to claim 16, comprising the receiving device and the transmitting device.

20. A recording medium which has a program recorded therein in such a manner that a computer contained in the server according to claim 19 can read the program,
the program causing the computer to function as the receiving device and the transmitting device.

21. A display method which is utilized in a display system which includes a display apparatus and a server, the display apparatus having a display device which displays information on a screen, and the server being connectable to the display apparatus via a network,
the display method comprising:
a process of the display apparatus transmitting technique information indicating a display technique utilized by the display device to the server;
a process of the server receiving the technique information transmitted from the display apparatus;
a process of the server transmitting a program in accordance with the received technique information to the display apparatus, the program being used for controlling an operation of the display apparatus;
a process of the display apparatus receiving the program transmitted from the server;
a process of the display apparatus converting a color of a display element having the largest display area among display elements constituting an image of the information displayed on the screen under control of the received program, to such a color as to minimize power consumption in the display operation, in accordance with the display technique utilized by the display device under control of the received program; and
a process of the display apparatus causing the display device to display the converted information under control of the received program.
